(19) United States
(12) Patent Application Publication
(10) Pub. No.: US 2011/0096733 A1
(43) Pub. Date: Apr. 28, 2011

(54) METHOD FOR SCHEDULING RESOURCE, NETWORK ELEMENT AND USER EQUIPMENT

(76) Inventors: Yan Zhao, Shanghai (CN); Tao Yang, Shanghai (CN); Jin Liu, Shanghai (CN)

(21) Appl. No.: 12/674,755

(22) PCT Filed: Aug. 24, 2007
(86) PCT No.: PCT/CN07/02565

§ 371 Date: Jan. 14, 2011

(51) Int. Cl. H04W 72/04

(52) U.S. Cl. 370/329

(57) ABSTRACT

The present invention proposes a method for scheduling resource in a packet network, a network element for exchanging signaling with user equipments and a user equipment, wherein user equipments communicate therebetween using the resource allocated by network elements, said communication comprises talk-spurt periods during which data packets are transmitted and silent periods during which silence descriptor packets are transmitted, said method for scheduling resource comprising: said network element allocates resource for said user equipment for communication; both said user equipment and said network element detect the presence of said silence descriptor packet; said user equipment stops using the allocated resource and said network element releases the allocated resource, when said silence descriptor packet is detected; said network element determines the end of the interval for transmitting said silence descriptor packet; said network element allocates new resource to said user equipment when said interval ends or when a request for allocating resource is received from said user equipment before the end of said interval.

### FIELD OF THE INVENTION

The present invention relates to the field of communication, and more particularly to scheduling resource in a packet network.

### BACKGROUND OF THE INVENTION

In recent years, due to especially higher data rate and support to mobility, broadband wireless access techniques, for example IEEE 802.16e, have drawn much attention, and are competing with the existing mobile communication systems. Therefore, 3GPP started a project of 3G long term evolution in 2005, to provide a better support for the increasing requirement of operators and users with evolved access technique (E-UTRA, Evolved-UTRA) and access network (E-UTRAN), in order to achieve the object of keeping UMTS system a superior one in the next 10 years or even longer time.

FIG. 1 shows the architecture of a version R7 LTE network. In such a network, the IP transmission is adopted between eNodeBs (Evolved Universal Terrestrial Radio Access Network NodeB) at lower layer, and the eNodeBs are interconnected logically via X2 interfaces, thus forming a meshed network. Such a network architecture plan is mainly used for supporting the mobility of user equipments (UE) within the entire network, and ensure the seamless handover of users. Each eNodeB is connected to access gateway(s) (aGW) by means of a certain form of meshed connection or partly meshed connection. A eNodeB may be connected to a plurality of aGWs, and vice versa. The LTE network employs the techniques of OFDM, MIMO, HARQ, AMC etc. at physical layer.

In such a LTE system, there only exists packet domain, and the voice traffic is carried via VoIP. The voice traffic is, the main traffic in current mobile communication systems, and tends towards being carried via IP. VoIP traffic has certain characteristics, such as smaller packet (generally with tens of bytes), substantially fixed arrival interval of packet and packet size, for example periodically generated for voice packet per 20 ms during talk-spurt period and SID (silence descriptor) packet per 160 ms during silent period.

In the downlink, OFDM may meet the requirements of data rate of 100 Mbit/s and spectrum efficiency, and may implement a flexible bandwidth configuration from 1.25 to 20 MHz. LTE follows the concept of HSDPA/HSUPA, i.e. obtaining a gain only by link adaptation and quick retransmission. The downlink modulation schemes of LTE include QPSK, 16QAM and 64QAM etc.

In uplink, SC-FDMA is employed, i.e. a base station allocates a single frequency to a UE for transmitting user's data per TTI (transmission time interval), and the data of different users is separated in frequency and time, so as to ensure the orthogonality among uplink carriers within a cell and avoid the interference among frequencies.

At present, there are some resource scheduling methods for LTE network, such as dynamic scheduling (DS), persistent scheduling (PS) and group scheduling (GS).

The dynamic scheduling means to schedule resource dynamically based on the channel condition. In downlink, the eNodeB allocates resource based on the amount of data in buffer, the channel condition etc. In uplink, an uplink resource request message is sent first when a UE wants to send uplink data. The eNodeB allocates resource based on the received request message via an uplink resource allocation message. Such a scheme has a better resource utilization and may adjust some parameters of MCS (modulation coding scheme) adaptively based on the channel condition. But it needs more bits for the scheduling request and the resource allocation information to achieve the adaptive adjustment, thus resulting in much signaling overhead.

If the dynamic scheduling is adopted for those smaller packets of VoIP traffic, i.e. a request and grant signaling per TTI, the signaling load will be much heavier. The overhead needs to be reduced for reaching a certain VoIP user amount in the LTE system. Hence, two optimized schemes are proposed, i.e. persistent scheduling and group scheduling.

A fully persistent scheduling is similar to the circuit switching allocation for VoIP, i.e. scheduling relatively fixed resource for the voice traffic once for all. This persistent scheduling is advantageous because of the reduced or avoided L1/L2 control signaling and simplicity. However, it has the lowest resource utilization among all scheduling methods, especially the resource unused by UE during silent period and unused HARP (Hybrid Automatic Repeat Request) retransmission resource. Moreover, since the time/frequency allocation is fixed and the MCS and resource selection is fixed during the whole persistent period configured when the call is set up, such a scheduling method lacks flexibility.

The group scheduling is to allocate resource from a set of resource blocks for a group of UEs. The numbers of resource block equals to the products of the numbers of UE and the average activity factor. The advantages of such a scheduling method are improved resource utilization and lower signaling overhead that the dynamic scheduling. However, this method has the following defects:
i) Difficult to manage the radio resource efficiently, especially because the average activity factor is hard to be estimated, which may cause extra delay to voice packet (at no resource case) or resource waste (at superfluous resource case).
ii) Lack of flexibility. Multi-rate codec will not be supported efficiently in a group; UE switching between groups or group reconfiguration are rather complex with a large amount of RRC (Radio Resource Control) signaling. The optimal performance is achieved only when the group is full, hence during the initial heating-up period the performance of group scheduling is low.
iii) Requiring different control channel structures, e.g. BITMAP signaling per TTI, from the normal L1/L2 control channel would be required.

To make efficient use of the resource, there is a need to find a trade-off between improving resource utilization and decreasing signaling overload.

### SUMMARY OF THE INVENTION

To solve the above problem in the prior art, according to a aspect of the present invention, a method for scheduling resource in a packet network is proposed, wherein user equipments communicate therebetween using the resource allocated by network elements, said communication comprises talk-spurt periods during which data packets are transmitted and silent periods during which silence descriptor packets are transmitted, the method comprises: said network element allocates resource for said user equipment for communication; both said user equipment and said network element detect the presence of said silence descriptor packet; said user equipment stops using the allocated resource and said network element releases the allocated resource when said silence descriptor packet is detected; said network element determines the end of the interval for transmitting said silence descriptor packet; said network element allocates new resource to said user equipment when said interval ends or when a request for allocating resource is received from said user equipment before the end of said interval.

According another aspect of the present invention, a network element for exchanging signaling with user equipments is proposed, wherein said user equipments communicate therebetween using the resource allocated by said network element, said communication is based on packet switching and comprises talk-spurt periods during which data packets are transmitted and silent periods during which silence descriptor packets are transmitted, the network element comprises: a detection means for detecting the presence of said silence descriptor packet or said data packet when said user equipment is communicating; a timer adapted to start timing when said silence descriptor packet is detected to determine the end of the interval for transmitting said silence descriptor packet; a state transition control means for transiting said network element from a talk-spurt state to a silent state when it detects said silence descriptor packet, or transiting said network element from the silent state to the talk-spurt state when it detects said data packet.

According to yet another aspect of the present invention, a user equipment is proposed, wherein said user equipment communicates with other user equipments using the resource allocated by network elements, said communication is based on packet switching and comprises talk-spurt periods during which data packets are transmitted and silent periods during which silence descriptor packets are transmitted, the user equipment comprises: a detection means for detecting the presence of said silence descriptor packet or said data packet when said user equipment is communicating; a state transition control means for transiting said user equipment from a talk-spurt state to a silent state when it detects said silence descriptor packet, or transiting said user equipment from the silent state to the talk-spurt state when it detects said data packet.

### BRIEF DESCRIPTION OF THE DRAWINGS

These and many other features and advantages of the present invention will become apparent from the following description of the embodiments of the present invention with reference to the drawings, wherein:

FIG. 1 shows the architecture of a LTE network;

FIG. 2 is a flowchart of the method for scheduling resource according to an embodiment of the present invention;

FIG. 3 further illustrates the method for scheduling resource according to the embodiment of the present invention;

FIG. 4 illustrates how the UE is synchronized in state with the eNodeB;

FIG. 5 is a block diagram of the network element according to an embodiment of the present invention;

FIG. 6 is a block diagram of the UE according to an embodiment of the present invention.

### DETAILED DESCRIPTION OF THE INVENTION

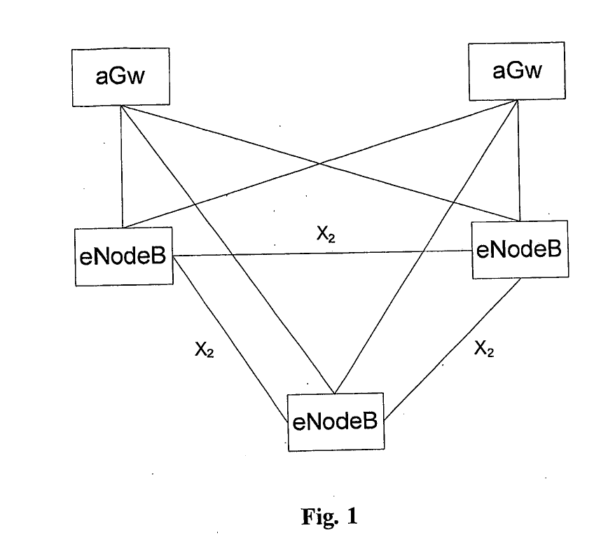

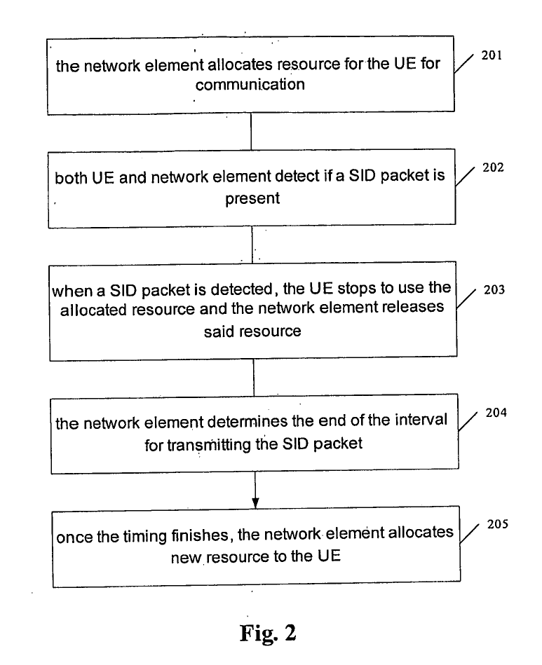

The present invention proposes a dual-state semi-persistent scheduling method for uplink VoIP in LTE. With reference to FIG. 2, the method for scheduling resource according to an embodiment of the present invention is described. This method may be applied to the system shown in FIG. 1. The description of the above system will not be repeated herein.

As shown in FIG. 2, firstly, in step 201, the network element allocates resource for the UE for communication. Herein, said network element may be for example the eNodeB shown in FIG. 1. In the present embodiment, any existing and future solution may be adopted for allocating resource, for example, but not exclusively eNodeB allocating resource for UE by means of the above-mentioned persistent scheduling method.

In step 202, both the UE and eNodeB detect if a SID packet (silence descriptor packet) is present, which may be performed for example by a detection means installed in UE and eNodeB. It should be noted that since the SID packet and the data packet such as the VoIP packet are encapsulated by RTP (Real-time Transport Protocol), RTP identifies at the corresponding indicator in the header of RTP to distinguish between SID packet and data packet. Furthermore, since the SID packet is relatively small (tens of bits) while the data packet has at least more than 100 bits (256 bits for 12.2 kbps), they could also be distinguished from the size of packet. Therefore, the SID packet and the data packet could be identified at the PDCP packet data convergence sub-layer.

Next, in step 203, for the detected SID packet, the UE stops to use the allocated resource and the eNodeB releases said resource, which may be allocated to other UEs. In step 204, eNodeB determines the end of the interval for transmitting the SID packet, for example by a timer installed in the eNodeB. For example, a timing interval of 160 ms may be set for the timer, such that the end of the interval for transmitting the SID packet could be determined when the timing finishes. Finally, in step 205, once the timing finishes, the eNodeB allocates new resource to the UE based on channel condition etc. There exists also such a case in practice, i.e. the UE requesting transmitting data packet, for example the VoIP voice packet, before the timer finishes its timing. In this case, if the UE sends a resource allocation request to the eNodeB, the eNodeB allocates new resource for the UE when receiving said request, after the detection of SID packet in the above step 203, and before the timer of eNodeB finishes its timing.

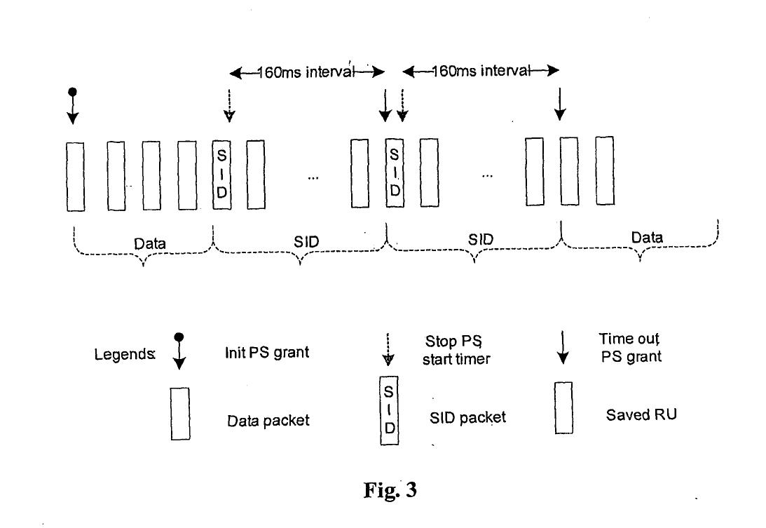

FIG. 3 further illustrates the method for scheduling resource according to the embodiment of the present invention. A situation is shown in which the data packet and the SID packet present alternately. It can be seen from the FIG. 3 that, when a SID packet, presents while the UE is communicating, meaning start of a silent period, the resource in the interval of 160 ms following the SID packet could be saved, and this saved resource may be allocated to other UEs. Once the timing of 160 ms finishes, the eNodeB allocates resource to said UE by the persistent scheduling method.

It should be appreciated that, the resource utilization may be improved when employing the method for scheduling resource of the present embodiment by allocating the remaining resource of the silent period of UE to other UEs. No new L1/L2 signaling is needed by using normal uplink scheduling grant signaling, and the grant signaling cost remains unchanged by using the persistent scheduling in the talk-spurt period. There is one grant per SID packet, such that each UE receives only an average of 3.125 grants signaling per second in the case of 0.5 activity factor.

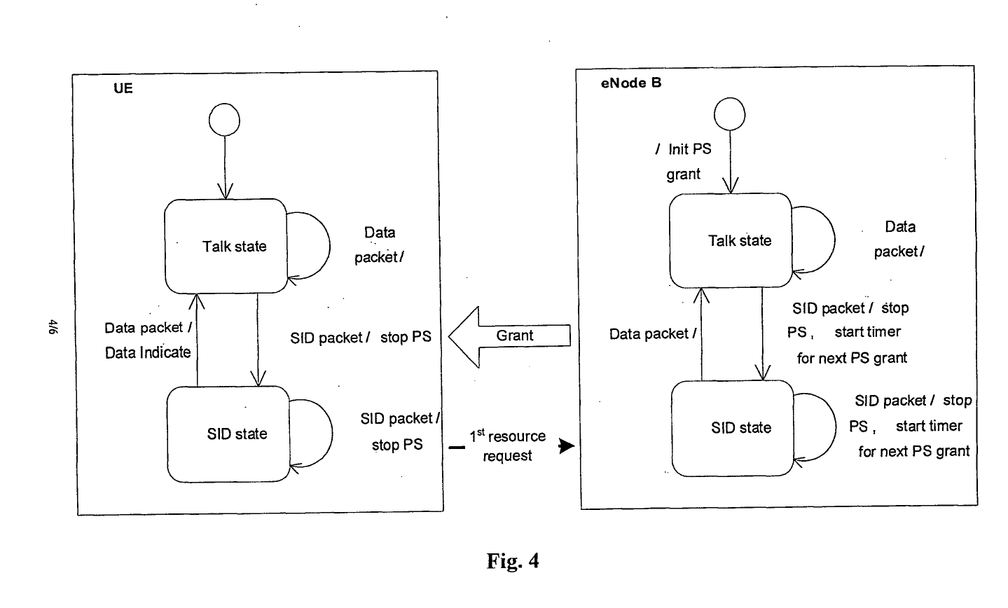

To save signaling cost, the method of the present embodiment synchronizes implicitly the UE and the eNodeB using grant synchronization state, to avoid resource allocation conflict among different UEs. This synchronization scheme makes eNodeB unnecessary to send a signaling to stop the last persistent grant before eNodeB allocates the resources assigned in the last persistent grant to other UEs. FIG. 4 illustrates how the UE is synchronized in state with the eNodeB.

It can be seen from FIG. 4 that, each UE has two states. One is talk-spurt state in which the UE is in talk-Spurt period, the other is SID state in which the UE is in silence period. A state transition means transition from the state before receiving trigger event to the state after executing actions. The format description of state transition may be for example “Trigger event/Action 1, action 2, and so on after triggering”, such as “SID packet/stop persistent scheduling” which means stopping the last persistent scheduling grant after receiving SID packet. “SID packet/stop persistent scheduling, start timer for next PS grant” means that the eNodeB stops the last persistent scheduling grant after receiving SID packet, then starts a timer to trigger a scheduler of eNodeB to generate a new persistent scheduling grant by the end of 160 ms. “Data packet/data indication” means generating a data indication after receiving data packet for triggering a scheduler of UE to send a resource request to the eNodeB, and transit its state. It can be seen from the figure that, when a UE in the SID state detects a data packet, the UE sends a resource allocation request to an eNodeB which allocates new resource for the UE immediately upon receiving said request.

Thereby, the signaling overhead is reduced greatly by synchronizing UE with eNodeB to avoid resource allocation conflict among different UEs.

It should be appreciated that, using the method for scheduling resource according to the present invention, the resource utilization may be improved without increasing signaling cost by detecting automatically the presence of SID packet both at UE and at eNodeB, employing the persistent scheduling during the talk-spurt period and synchronizing the states of UE and eNodeB, and reallocating the remaining resource of UE during the silent period to other UEs.

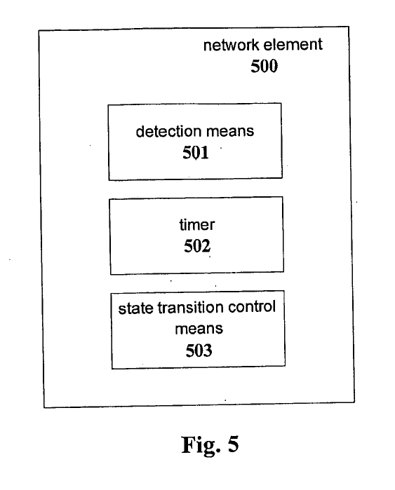

Based on the same inventive concept, according to another aspect of the present invention, a network element is proposed for exchanging signaling with UEs. The network element will be described in the following with reference to FIG. 5.

FIG. 5 is a block diagram of the network element 500 according to an embodiment of the present invention, which is for example eNodeB. The network element 500 includes a detection means 501, a timer 502 and a state transition control means 503. The detection means 501 is used for detecting the presence of SID packet or data packet when the UE is communicating. The timer 502 is used for starting timing when a SID packet is detected by the detection means 501. In the present embodiment, the timing period of the timer 502 may be set as 160 ms. Referring to FIG. 4 again, the state transition control means 503 is used for transiting the network element from the talk-spurt state to the SID state, and vice versa. The state transition is triggered by the trigger event as shown in FIG. 4. The resource scheduling grant for, the UE is stopped when a SID packet is detected by the detection means 501, and the timer 502 starts timing. The network element 500 allocates new resource for the UE, when the timer 502 finishes its timing, or when the UE requests the network element 500 to allocate resource to it before the finish of timing.

In implementation, the network element 500 of this embodiment as well as the detection means 501, the timer 502 and the state transition control means 503 it includes, may be implemented in software, hardware or a combination of them. For example, those skilled in the art are familiar with a variety of devices which may be used to implement these components, such as micro-processor, micro-controller, ASIC, PLD and/or FPGA etc. The detection means 501, the timer 502 and the state transition control means 503 of the present embodiment may be either implemented as integrated into the network element 500, or implemented separately, and they may also be implemented separately physically but interconnected operatively.

In operation, said network element for exchanging signaling with UEs of the embodiment illustrated in connection with FIG. 5, may improve the resource utilization without increasing signaling cost, by detecting automatically the presence of SID packet both at UE and at eNodeB, by employing the persistent scheduling, during the talk-spurt period and synchronizing the states of UE and eNodeB, and by reallocating the remaining resource of UE during the silent period to other UEs.

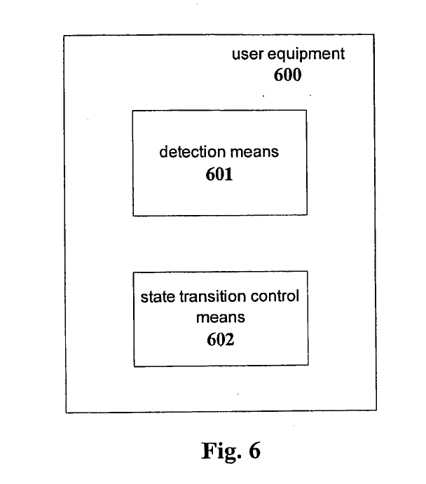

Based on the same inventive concept, according to yet another aspect of the present invention, a user equipment is proposed. The user equipment will be described in the following with reference to FIG. 6.

FIG. 6 is a block diagram of the UE 600 according to an embodiment of the present invention. The UE 600 includes a detection means 601 and a state transition control means 602. The detection means 601 is used for detecting the presence of SID packet or data packet when the UE is communicating. The state transition control means 602 is used for transiting the UE from talk-spurt state to SID state, and vice versa. The state transition is triggered by a trigger event as shown in FIG. 4. When the detection means 601 detects a SID packet, the UE stops using the resource allocated by the network element. When the detection means 601 detects a data packet while the UE is in silent state, the UE sends a request for allocating resource to the network element.

In implementation, the UE 600 of this embodiment as well as the detection means 601 and the state transition control means 602 it includes, may be implemented in software, hardware or a combination of them. For example, those skilled in the art are familiar with a variety of devices which may be used to implement these components, such as micro-processor, micro-controller, ASIC, PLD and/or FPGA etc.

In operation, said UE of the embodiment illustrated in connection with FIG. 6, may improve the resource utilization without increasing signaling cost, by detecting automatically the presence of SID packet both at UE and at eNodeB, by employing the persistent scheduling during the talk-spurt period and synchronizing the states of UE and eNodeB, and by reallocating the remaining resource of UE during the silent period to other UEs.

Although the exemplary embodiments of the method for scheduling resource, the network element for exchanging signaling with UEs and the UE of the present invention are described above in detail, the above embodiments are not exhaustive, and those skilled in the art can make numerous changes and modifications within the spirit and scope of the present invention. Therefore, the present invention is not limited to those embodiments, the scope of which is defined only by the appended claims.

1. A method for scheduling resource in a packet network, wherein user equipments communicate therebetween using the resource allocated by a network element, said communication comprises talk-spurt periods during which data packets are transmitted and silent periods during which silence descriptor packets are transmitted, the method comprising:
said network element allocates resource for said user equipments for communication;
both said user equipments and said network element detect the presence of said silence descriptor packet;
said user equipments stop using the allocated resource and said network element releases the allocated resource when said silence descriptor packet is detected;
said network element determines the end of the interval for transmitting said silence descriptor packet;
said network element allocates new resource to said user equipment when said interval ends or when a request for allocating resource is received from said user equipment before the end of said interval.

2. The method according to claim 1, wherein said silence descriptor packet is transmitted once per 160 ms during said silent period, and said data packet is transmitted once per 20 ms during said talk-spurt period.

3. The method according to claim 1, wherein said network element determines the end of the interval by timing.

4. The method according to claim 1, wherein the period of said timing is 160 ms.

5. The method according to claim 1, further comprising said network element reallocating the released resource to other user equipments, when said other user equipments request said network element to allocate resource.

6. A network element for exchanging signaling with user equipments, wherein said user equipments communicate therebetween using the resource allocated by the network element, said communication is based on packet switching and comprises talk-spurt periods during which data packets are transmitted and silent periods during which silence descriptor packets are transmitted, the network element comprising:
detection means for detecting the presence of said silence descriptor packet or said data packet when said user equipment is communicating;
timer adapted to start timing when said silence descriptor packet is detected to determine the end of the interval for transmitting said silence descriptor packet;
state transition control means for changing said network element from a talk-spurt state to a silent state when it detects said silence descriptor packet, or changing said network element from the silent state to the talk-spurt state when it detects said data packet.

7. The network element according to claim 6, wherein said silence descriptor packet is transmitted once per 160 ms during said silent period, and said data packet is transmitted once per 20 ms during said talk-spurt period.

8. The network element according to claim 6, wherein when said network element changes from said talk-spurt state to said silent state, it stops the resource scheduling grant for said user equipment, and said timer start timing; and when said network element changes from said silent state to said talk-spurt state, it allocates new resource for said user equipment.

9. The network element according to claim 6, wherein the period of said timing is 160 ms.

10. A user equipment, wherein said user equipment communicates with other user equipments using the resource allocated by network elements, said communication is based on packet switching and comprises talk-spurt periods during which data packets are transmitted and silent periods during which silence descriptor packets are transmitted, the user equipment comprising:
detection means for detecting the presence of said silence descriptor packet or said data packet when said user equipment is communicating;
state transition control means for changing said user equipment from a talk-spurt state to a silent state when it detects said silence descriptor packet, or changing said user equipment from the silent state to the talk-spurt state when it detects said data packet.

11. The user equipment according to claim 10, wherein said silence descriptor packet is transmitted once per 160 ms during said silent period, and said data packet is transmitted once per 20 ms during said talk-spurt period.

12. The user equipment according to claim 10, wherein when said user equipment changes from said talk-spurt state to said silent state, it stops using the resource allocated by said network element, and when said user equipment changes from said silent state to said talk-spurt state, it sends a request for allocating resource to said network element.
